(19) United States
(12) Patent Application Publication
(10) Pub. No.: US 2012/0020108 A1
(43) Pub. Date: Jan. 26, 2012

(54) LED LIGHTING DEVICE

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/048,876

(22) Filed: Mar. 16, 2011

(30) Foreign Application Priority Data
Jul. 22, 2010 (CN) 201010234154.9

(51) Int. Cl. F21V 8/00

(52) U.S. Cl. 362/555

(57) ABSTRACT

An LED lighting device includes at least one circuit board, an encapsulation, a number of LED light sources, and a light guiding member. The LED light sources are distributed on the circuit board. The encapsulation is arranged around the light guiding member. The light guiding member includes two opposite surfaces, at least one of which defines a number of accentuated portions. At least one end of the light guiding member includes a light incident surface opposing the LED light sources. After entering the light guiding member from the light incident surface, the light beams from the LED light sources are reflected between the opposite surfaces of the light guiding member. The light beams reaching the accentuated portions are diffused and exit the light guiding member, and are finally transmitted to outside through the encapsulation.

### BACKGROUND

1. Technical Field

The present disclosure relates to lighting devices and, particularly, to a fluorescent lamp type LED lighting device with a good radiation angle.

2. Description of Related Art

With the advantages of long service life, low pollution, power conservation, and other benefits, light-emitting diodes (LEDs) are now being widely used in lighting devices. An LED is a point light source with a small radiation angle and strong directionality. To maximize illuminated surface area, light-emitting diodes are often distributed in rows on the LED lighting device. However, compared to the almost 360° radiation angle of fluorescent lamps, the radiation angle of a commonly used LED fluorescent lamp is only about 100° to 140°. Further, high brightness LEDs cause light spots on the lighting emitting surface of the LED lighting device. In order to reduce or eliminate the light spots and achieve uniform lighting, an extra light diffusion film is needed, which may absorb part of the light from the light-emitting diodes, resulting in brightness of the LED lighting device being reduced.

Therefore, what is needed is an LED lighting device to overcome the above-mentioned shortcomings.

### BRIEF DESCRIPTION OF THE DRAWINGS

Many aspects of the embodiments can be better understood with reference to the following drawings. The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is a schematic, view of an LED lighting device according to a first embodiment.

FIG. 2 is a cross-sectional view cut along line II-II of the LED lighting device of FIG. 1.

FIG. 3 is a lighting schematic view of an LED lighting device according to a second embodiment.

FIG. 4 is a cross-sectional view of an LED lighting device according to a third embodiment.

FIG. 5 is a cross-sectional view of an LED lighting device according to a fourth embodiment.

FIG. 6 is a cross-sectional view an LED lighting device according to a fifth embodiment.

### DETAILED DESCRIPTION

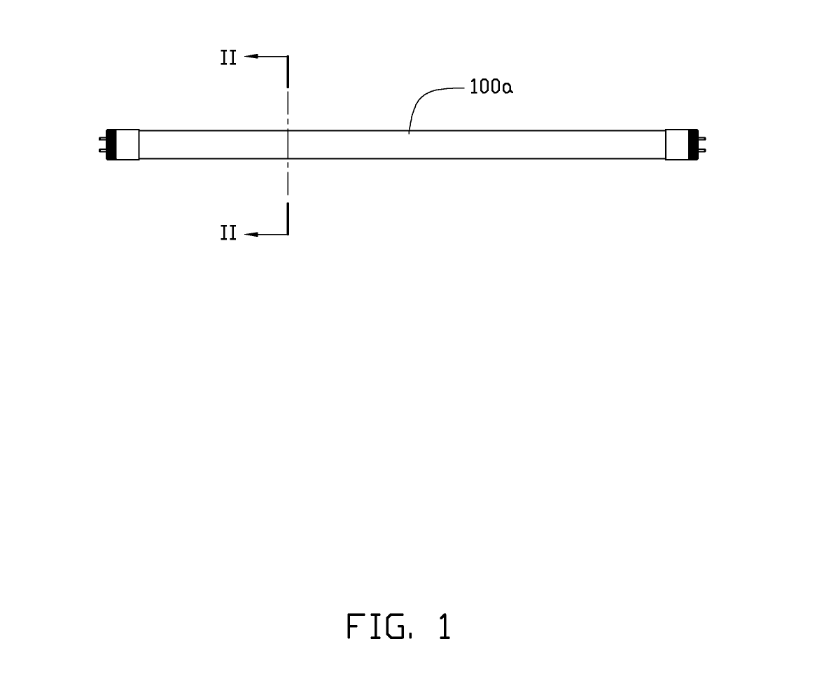

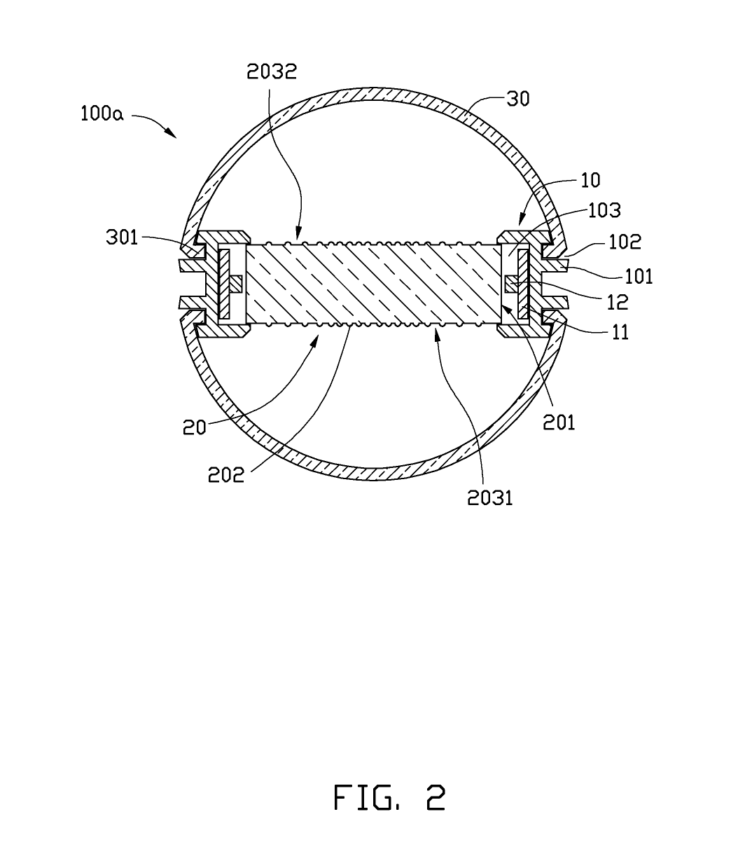

Referring to FIGS. 1 and 2, an LED lighting device 100a according to a first embodiment is illustrated. The LED lighting device 100a, which is shaped like a conventional fluorescent tube, includes a pair of heat sinks 10, a pair of circuit boards 11, a plurality of LED light sources 12, a light guiding member 20, and a pair of encapsulations 30.

The light guiding member 20 is detachably connected to the heat sinks 10. In the embodiment, one end of each heat sink 10 defines a hollow space 103. Two ends of the light guiding member 20 are received in the hollow space 103 of the corresponding heat sink 10, such that the light guiding member 20 is arranged between the heat sinks 10. The other opposite end of each heat sink 10 defines a number of fins 101 evenly spaced from each other by a predefined distance and a pair of grooves 102 in opposite sides of the fins 101. The circuit board 11 is arranged in the hollow space 103. The LED light sources 12 are distributed in a row on each circuit board 11. The heat generated by the LED light sources 12 can be transferred to the ambient air through the fins 101 of the heat sinks 10.

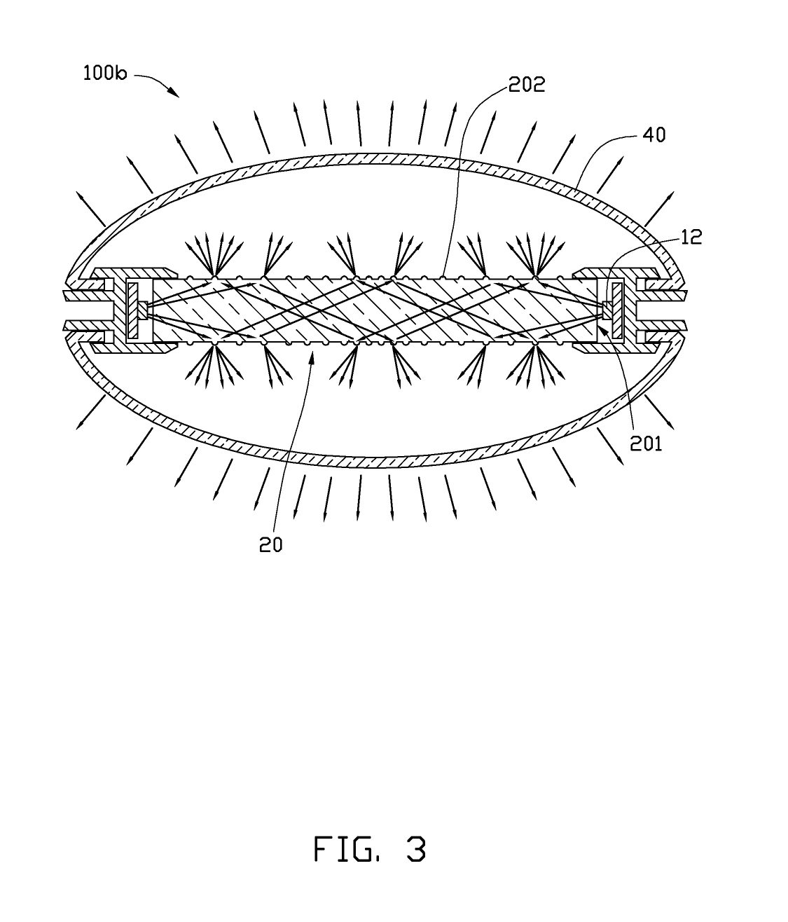

The encapsulations 30 are arranged around the light guiding member 20. In the embodiment, each of the encapsulation 30 is formed to be a semi-circular structure. In an alternative embodiment, as shown in FIG. 3, an encapsulation 40 is formed to be a semi-elliptical structure. Come back to FIG. 2, each end of the encapsulations 30 includes an inward projecting member 301. The corresponding inward projecting member 301 is engaged in the corresponding groove 102 of the heat sinks 10 to arrow the light guiding member 20 to be arranged in the encapsulations 30.

The light guiding member 20 is made of optical material. Each end of the light guiding member 20 includes a light incident surface 201 opposing the LED light sources 12. The light guiding member 20 includes two opposite reflective surfaces 2031 and 2032. In order to adjust the illumination positions and the illumination intensity on the surfaces of the light guiding member 20, a plurality of accentuated portions 202, such as protuberances and/or recesses are defined at the surfaces of the light guiding member 20.

The encapsulations 30 are made of diffusion material which includes a plurality of methyl methacrylate particles. The methyl methacrylate particles function as diffusion particles to further diffuse the light beams entering the encapsulations 30, such that a uniform and soft effect can be achieved outside the encapsulations 30. In the embodiment, the encapsulations 30 are substantially arc-shaped, such as being semi-circular. In an alternative embodiment, as shown in FIG. 3, an encapsulation 40 is semi-elliptical.

Referring to FIG. 3, in use, after entering the light guiding member 20 from the light incident surfaces 201, the light beams from the LED light sources 12 are reflected between the opposite surfaces of the light guiding member 20. The light beams reaching the accentuated portions 202 are diffused and exit the light guiding member 20, and are finally transmitted to outside through the encapsulation 40.

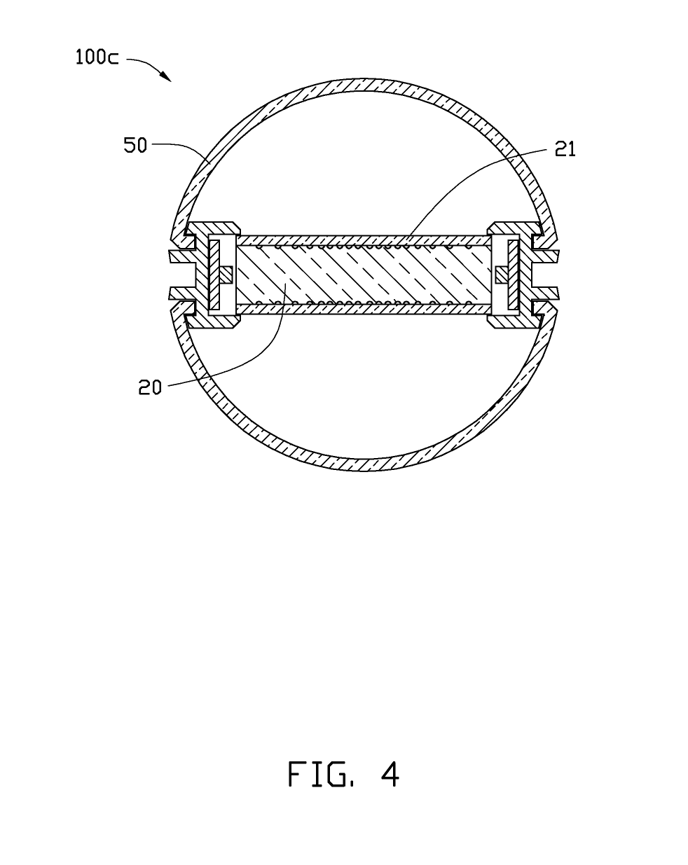

In an alternative embodiment, as shown in FIG. 4, an encapsulation 50 may be made of transparent material, and a diffusion layer 21 is applied to each surface of the light guiding member 20.

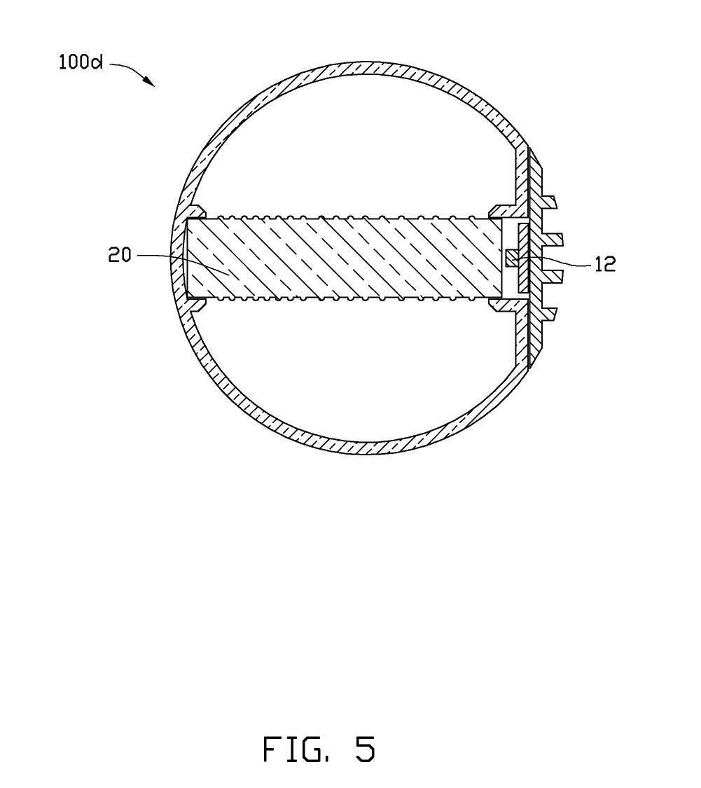

In an alternative embodiment, as shown in FIG. 5, the LED light sources 12 are only arranged at one end of the light guiding member 20.

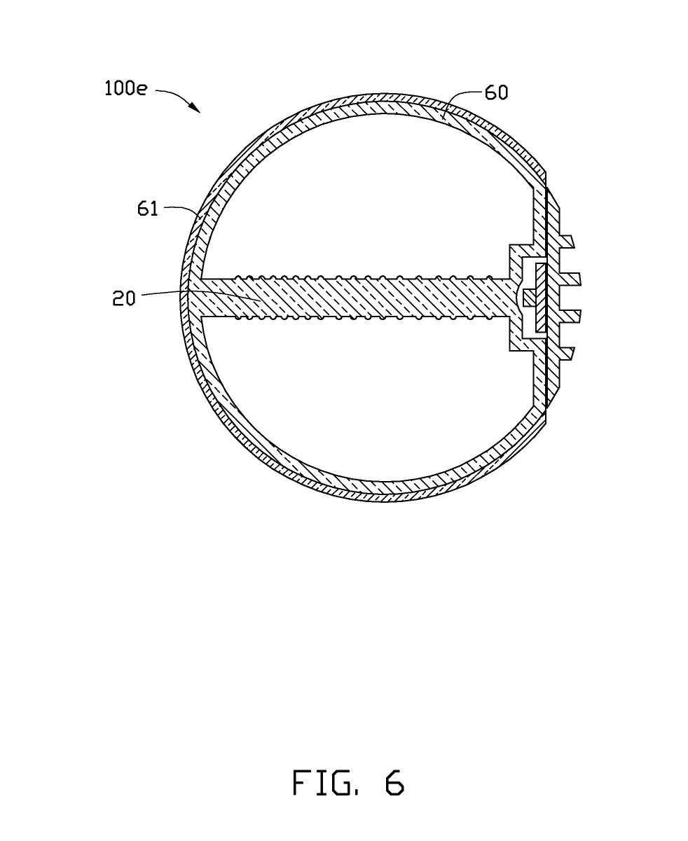

In another embodiment, as shown in FIG. 6, an encapsulation 60 and the light guiding member 20 are integrally formed. The encapsulation 60 is made of transparent material, and a diffusion layer 61 is applied to the outside surface of the encapsulation 60.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A light emitting diode (LED) lighting device comprising:
at least one circuit board;
a plurality of LED light sources distributed on the circuit board;
a light guiding member comprising two opposite surfaces, at least one of the opposite surfaces defining a plurality of accentuated portions, at least one end of the light guiding member comprising a light incident surface opposing the LED light sources; and
an encapsulation arranged around the light guiding member;
wherein after entering the light guiding member from the light incident surface, the light beams from the LED light sources are reflected between the opposite surfaces of the light guiding member; the light beams reaching the accentuated portions are diffused and exit the light guiding member, and are finally transmitted to outside through the encapsulation.

2. The LED lighting device of claim 1, wherein the encapsulation is formed to be two semi-circular structures, each end of which defines an inward projecting member.

3. The LED lighting device of claim 1, wherein the encapsulation is formed to be two semi-elliptical structures, each end of which defines an inward projecting member.

4. The LED lighting device of claim 2, further comprises a pair of heat sinks, wherein one end of each heat sink defines a hollow space, two ends of the light guiding member are received in the hollow space of the corresponding heat sink, such that the light guiding member is arranged between the heat sinks.

5. The LED lighting device of claim 4, wherein the other opposite end of each heat sink defines a pair of grooves in opposite sides thereof, the corresponding inward projecting member is engaged in the corresponding groove of the heat sinks to arrow the light guiding member to be arranged in the encapsulation.

6. The LED lighting device of claim 1, wherein the encapsulation is made of diffusion material.

7. The LED lighting device of claim 1, wherein the encapsulation is made of transparent material, and a diffusion layer is applied to each surface of the light guiding member.

8. The LED lighting device of claim 1, wherein the encapsulation is made of transparent material, and a diffusion layer is applied to the outside surface of the encapsulation.

9. The LED lighting device of claim 1, wherein the encapsulation and the light guiding member are integrally formed.
